(19) United States
(12) Patent Application Publication
(10) Pub. No.: US 2015/0098751 A1
(43) Pub. Date: Apr. 9, 2015

(54) BI-DIRECTIONAL BREAK-AWAY JOINT

(71) Applicant: AGCO Corporation, Hesston, KS (US)

(72) Inventors: Michael BIDNE, Jackson, MN (US); Glen David KROESE, Jackson, MN (US); Jeff BERANEK, Jackson, MN (US)

(21) Appl. No.: 14/507,136

(22) Filed: Oct. 6, 2014

Related U.S. Application Data
(60) Provisional application No. 61/886,894, filed on Oct. 4, 2013.

(51) Int. Cl. A01M 7/00; A01C 7/08

(52) U.S. Cl. CPC A01M 7/0078; A01C 7/08
USPC 403/83

(57) ABSTRACT

A break-away joint apparatus is disclosed for a boom arm having a front side and a back side, the boom arm having a main boom portion and a boom tip. The apparatus allows the boom tip to assume a neutral position and to pivot to a forward position and to a rearward position with respect to the main boom portion. The apparatus includes a first hinge connected to the main boom portion proximate one of the front or back side of the boom arm; a second hinge connected to the boom tip proximate an opposite side of the boom arm; and a pivot plate having first and second opposite sides, the first side connected to the first hinge and the second side connected to the second hinge.

### CROSS REFERENCE TO RELATED APPLICATION

This application claims priority to U.S. Provisional Application No. 61/886,894, filed Oct. 4, 2013, entitled “BI-DIRECTIONAL BOOM BREAK-AWAY JOINT” which is hereby incorporated by reference in its entirety.

### BACKGROUND OF THE INVENTION

1. Field of Invention

This invention relates generally to agricultural seed planters, and more particularly to a mechanism for delivering seed from the seed meter to the open seed trench.

2. Description of Related Art

A crop sprayer may be in the form of an agricultural vehicle or may be mounted to an agricultural vehicle. The crop sprayer may spray a fluid including herbicides, pesticides, and fertilizers on agricultural crops in a field. The fluid may be sprayed from nozzles mounted on a boom on the crop sprayer. Large agricultural sprayers typically have horizontal booms to allow for extensive spray coverage of crops in a field with a single travel pass. In some cases, booms have a length between about 20 and about 150 feet.

With conventional crop sprayers, an operator may drive the crop sprayer forward in a field. As the crop sprayer moves in the field, the boom (or more specifically, a boom tip) may impact an obstacle (such as a tree, power pole, fence or post, for example), or force may otherwise be applied to the boom. This impact or force may damage the boom, the boom tip and/or the obstacle.

In some commercially produced chemical application booms, the boom tips are configured to break away rearwardly as the sprayer moves forward. However, in some cases, such as when the sprayer travels backward, the boom encounters an obstacle wherein it is pushed forwardly. Many boom tips are not designed to break away forwardly; thus, the boom may sustain extensive damage.

### SUMMARY OF THE INVENTION

In one aspect, a break-away joint apparatus is disclosed for a boom arm having a front side and a back side, the boom arm comprising a main boom portion and a boom tip. The apparatus allows the boom tip to assume a neutral position and to pivot to a forward position and to a rearward position with respect to the main boom portion. The apparatus comprises a first hinge connected to the main boom portion proximate one of the front or back side of the boom arm; a second hinge connected to the boom tip proximate an opposite side of the boom arm; and a pivot plate having first and second opposite sides, the first side connected to the first hinge and the second side connected to the second hinge.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a side elevation view of an exemplary boom arm.

FIG. 2A is a top plan view of an exemplary boom arm in a forward break configuration, as if mounted on an implement traveling in direction T.

FIG. 2B is a top plan view of an exemplary boom arm in a rearward break configuration, as if mounted on an implement traveling in direction T.

FIG. 3A is a top perspective view of the exemplary boom in a forward break configuration, as if mounted on an implement traveling in direction T.

FIG. 3B is a top perspective view of the exemplary boom in a rearward break configuration, as if mounted on an implement traveling in direction T.

FIG. 4 is a top view of a joint between a boom tip and main boom portion of a boom arm, with the boom arm in a neutral or closed position (with the boom tip pivoted neither forward nor backward from the main boom portion).

FIG. 5A is a top plan view of an exemplary boom arm in a forward break configuration, as shown in FIGS. 2A and 3A.

FIG. 5B is a top plan view of an exemplary boom arm in a rearward break configuration, as shown in FIGS. 2B and 3B.

FIG. 6 is a top plan view of a second embodiment of an exemplary joint between a boom tip and main boom portion of a boom arm, with the boom arm in a neutral or closed position (with boom tip pivoted neither forward nor backward from the main boom portion).

FIG. 7 is an elevation view of an exemplary pivot plate of the joint of FIG. 6.

FIG. 8 is a top plan view of a joint with a first embodiment of a return mechanism.

FIG. 9 is a top plan view of a joint with a second embodiment of a return mechanism.

FIG. 10A is a side perspective view of a hinge that embodies a third embodiment of a return mechanism.

FIG. 10B is a side perspective view of the hinge of FIG. 10A with a top section thereof rotated with respect to a bottom section thereof, about the hinge axis.

FIG. 11A is a side perspective view of a second hinge that embodies a fourth embodiment of a return mechanism.

FIG. 11B is a side elevation view of a portion of the top section of the hinge of FIG. 11A, from vantage B.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where terms such as above, below, over, under, top, bottom, side, right, left, etc., are used, it is to be understood that they are used only for ease of understanding the description. It is contemplated that structures may be oriented otherwise.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

A break-away joint assembly of the present disclosure allows a boom tip to break away to the front or rear of the agricultural vehicle without damaging the agricultural vehicle or the boom arm when the boom tip impacts an obstacle or when a sufficient force is otherwise applied to the boom tip. Release of the boom tip diminishes the stress placed on the boom arm and mounting apparatus.

A boom arm with a bi-directional boom-tip break-away feature is described that can be used, for example, on liquid sprayers. A suitable liquid sprayer is disclosed in U.S. Patent Application Publication No. 2012/0237284, assigned to AGCO Corporation, and entitled “Boom fore and aft breakaway assembly,” the disclosure of which is fully incorporated by reference herein. Another suitable liquid sprayer is disclosed in U.S. Pat. No. 7,823,803, assigned to AGCO Corporation, and entitled “Integrated breakaway cylinder and method for constructing a boom assembly,” the disclosure of which is fully incorporated by reference herein. A boom arm of the present disclosure may be attached to a liquid sprayer by conventional means. An exemplary break-away boom arm of the present disclosure allows the boom tips to hinge backward or forward upon contact with an obstruction in the field.

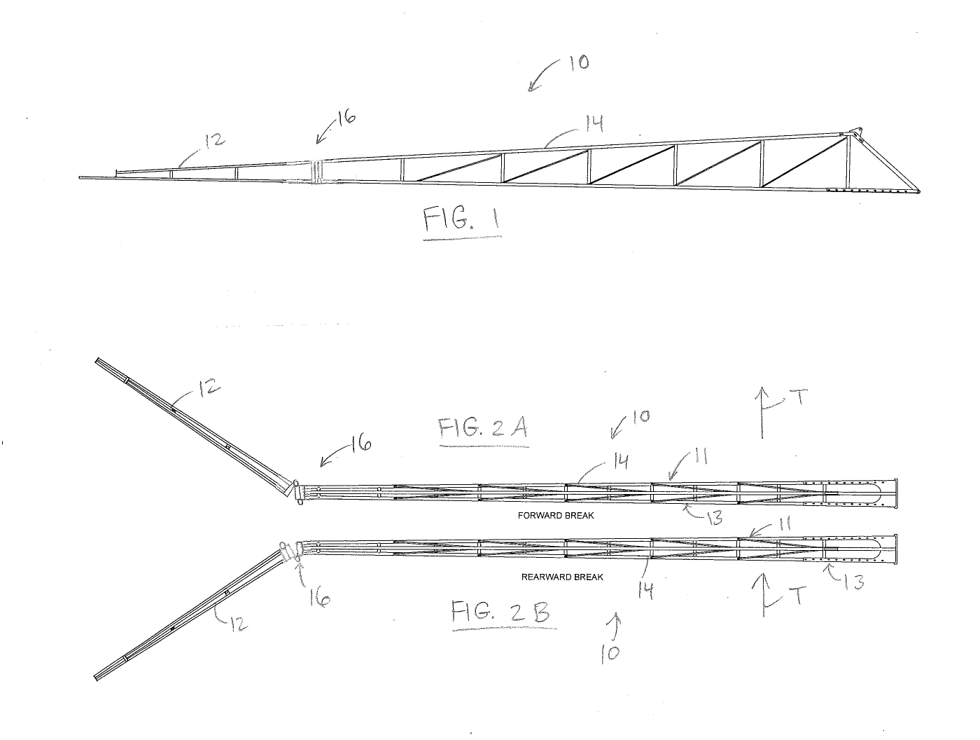

FIG. 1 is a side elevation view of horizontally extending boom arm 10 with an exemplary break-away joint apparatus 16 in a neutral position (i.e., with boom tip 12 not pivoted forward or backward from main boom portion 14). In an exemplary embodiment, boom arm 10 is a truss assembly of aluminum pieces; boom arm 10 supports a plurality of liquid spray nozzles (not shown). As shown in FIGS. 2A and 2B, boom arm 10 has a front side 11 and a back side 13 with respect to a direction of travel T. FIG. 2A is a top plan view of an exemplary boom arm 10 in a forward break configuration, with boom tip 12 pivoted forward from main boom portion 14. FIG. 2B is a top plan view of boom arm 10 in a rearward break configuration, with boom tip 12 pivoted rearward from main boom portion 14. The structure and operation of an apparatus at joint 16 between main boom portion 14 and boom tip 12 is further described below.

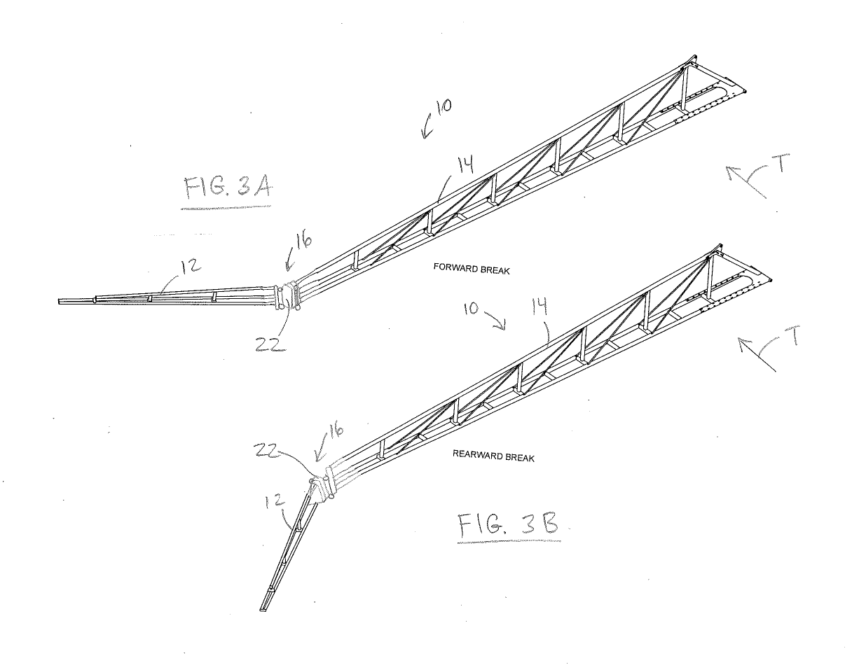

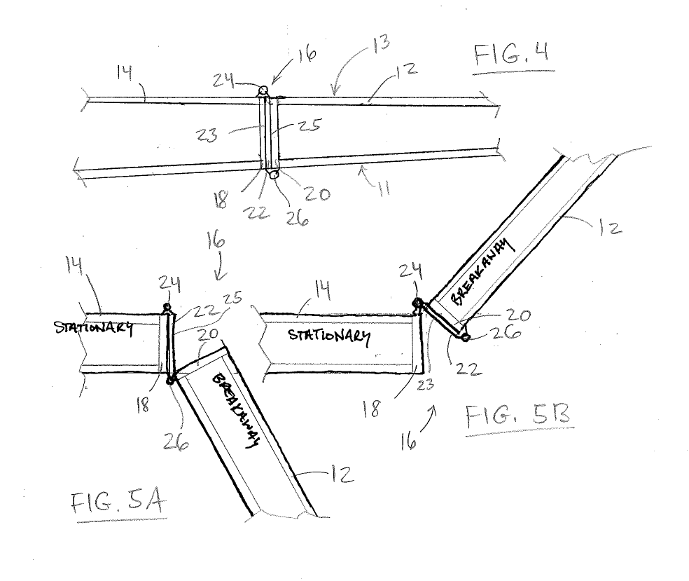

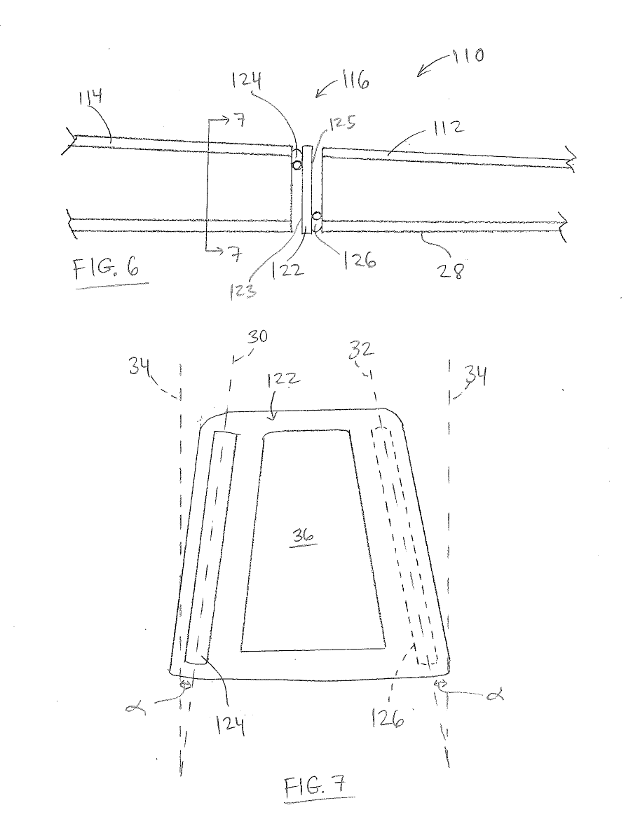

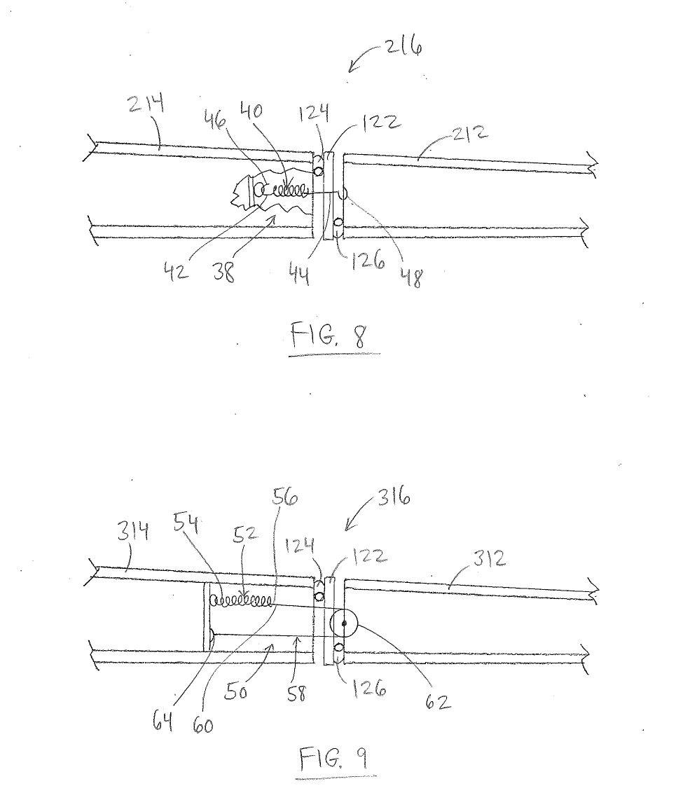

FIG. 3A is a top perspective view of boom arm 10 in a forward break configuration, the top view of which is shown in FIG. 2A. FIG. 3B is a top perspective view of boom arm 10 in a rearward break configuration, the top view of which is shown in FIG. 2B. FIG. 4 is a top view of joint 16 between boom tip 12 and main boom portion 14 of boom arm 10, with boom arm 10 in a neutral or closed position (i.e., with boom tip 12 pivoted neither forward nor backward from main boom portion 14).

In an exemplary embodiment, main boom portion 14 includes end plate 18, and boom tip 12 includes end plate 20. Pivot plate 22 is positioned between end plates 18 and 20. While the term “plate” is used, it is to be understood that plates 18, 20 and 22 need not be flat. In an exemplary embodiment, hinge 24 connects plate 18 and pivot plate 22 proximate back side 13 of boom arm 10; hinge 26 connects plate 20 and pivot plate 22 proximate front side 11 of boom arm 10. Pivot plate 22 includes first and second opposite sides 23, 25; hinge 24 is connected to first side 23 and hinge 26 is connected to second side 25. The illustrated construction offers hinged connections for both forward and rearward pivoting movement of boom tip 12 relative to main boom portion 14. In one embodiment, end plates 18, 20 are not used; rather, hinges 24 and 26 are connected to other end structures of main boom portion 14 and boom tip 12.

Boom arm 10 is shown in a neutral or closed position in FIG. 4, with boom tip 12 pivoted neither forward nor backward from main boom portion 14. In one embodiment, plates 18, 20 and 22 lie flat against each other. In one embodiment, hinges 24, 26 are parallel to each other. FIG. 5A is a top plan view of boom arm 10 in a forward break configuration, as shown in FIGS. 2A and 3A. Boom tip 12 pivots away from main boom portion 14 via hinge 26, while pivot plate 22 remains against main boom portion 14. FIG. 5B is a top plan view of boom arm 10 in a rearward break configuration, as shown in FIGS. 2B and 3B. In this case, boom tip 12 pivots away from main boom portion 14 via hinge 24, while pivot plate 22 remains against boom tip 12.

FIG. 6 is a top plan view of a second exemplary joint 116 between boom tip 112 and main boom portion 114 of a boom arm, with boom arm 110 in a neutral or closed position (i.e., with boom tip 112 pivoted neither forward nor backward from the main boom portion 114). FIG. 7 is a side elevation view of an exemplary pivot plate 122 of joint 116. Pivot plate 122 has opposite front and back sides 123, 125, when viewed from line 7-7 of FIG. 6. In the illustration, hinge 126 is shown in phantom because it is positioned on the back side 125 of pivot plate 122. In an exemplary embodiment, pivot plate 122 includes central aperture 36 therethrough to reduce weight and material usage.

In the embodiment of FIGS. 6 and 7, hinges 124, 126 of joint 116 are not normal or perpendicular with respect to the bottom surface 28 of boom arm 110 (which, when its associated sprayer is disposed on a horizontal surface, is also generally horizontal). Rather, hinge axis 30 of hinge 124 is disposed at an acute angle alpha with respect to a line 34 that is perpendicular to bottom surface 28 of boom arm 110. In an exemplary embodiment, hinge axis 32 of hinge 126 is disposed at the same acute angle alpha (though in an opposite orientation) with respect to a line 34 that is perpendicular to bottom surface 28 of boom arm 110. However, in another embodiment, the hinges 124, 126 need not be inclined at the same angle. For example, hinge 124 may be inclined at angle alpha and hinge 126 may be inclined at an angle beta that is different from alpha.

In an exemplary embodiment, both of hinges 124, 126 are inclined to converge at a top of pivot plate 122 (i.e, to be closer to each other at a top and farther from each other at a bottom of pivot plate 122). In an exemplary embodiment, alpha is between about 10 degrees and about 20 degrees, and is most suitably about 15 degrees. Because of the inclination of hinges 124, 126, boom tip 112 becomes aligned slightly upward as well as forward (as shown in FIG. 3A) or rearward (as shown in FIG. 3B) relative to main boom portion 114 when pivoted at joint 116. When the obstacle that caused the forward or rearward pivoting of boom tip 112 relative to main boom portion 114 is passed, gravity assists in returning boom tip 112 to the neutral position shown in FIGS. 1 and 6. Other angles outside of the 10-20 degree range may be used, but smaller angles will not offer as much gravity assistance for the boom tip to return to its unpivoted position, and larger angles will result in additional stresses on joint 116.

FIG. 8 is a top plan view of joint 216 with a first embodiment of a return mechanism 38. Return mechanism 38 includes a linear helical spring 40 having a first end 42 attached to main boom portion 214 and a second end 44 attached to boom tip 212. Such attachment may be by conventional means, such as, for example, by the use of hooks 46, 48 and associated hook engaging elements (not shown) on the main boom portion 214 and boom tip 212, respectively. Joint 216 is shown in the neutral position, analogous to the position of joint 16, 116 shown in FIGS. 4 and 6. When boom tip 212 pivots away from main boom portion 214 (analogous to the positions shown in FIGS. 5A and 5B), a length of spring 40 increases. When the obstacle that caused the forward or rearward pivoting of boom tip 212 relative to main boom portion 214 is passed, the recovery forces of spring 40 cause it to return to its original length, thereby pulling boom tip 212 back into the neutral position of FIG. 8. While a helical spring 40 is shown, it is contemplated that other elastic elements can also be used.

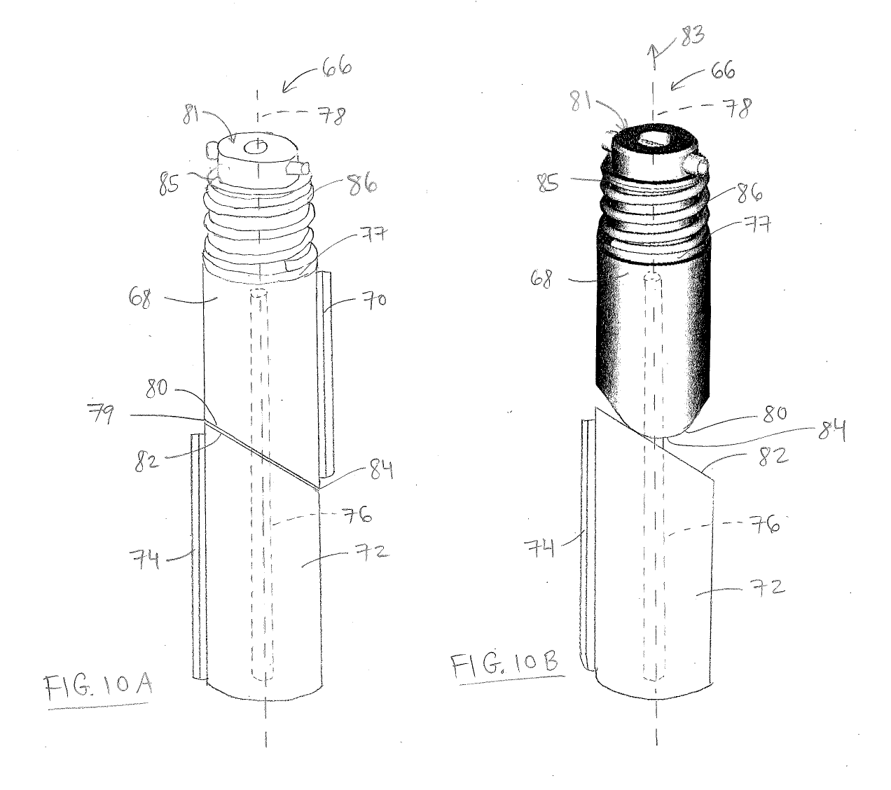

FIG. 9 is a top plan view of joint 316 with a second embodiment of a return mechanism 50. Return mechanism 50 includes a linear helical spring 52 having a first end 54 attached to main boom portion 314 and a second end 56 attached to cable 58 at the first end 60 of cable 58. Cable 58 extends around pulley 62, which is attached to boom tip 312. A second end 64 of cable 58 is fixed to main boom portion 314. Joint 316 is shown in the neutral position, analogous to the position of joint 16, 116 shown in FIGS. 4 and 6. When boom tip 312 pivots away from main boom portion 314 (analogous to the positions shown in FIGS. 5A and 5B), a length of spring 52 increases. When the obstacle that caused the forward or rearward pivoting of boom tip 312 relative to main boom portion 314 is passed, the recovery forces of spring 52 cause it to return to its original length, thereby pulling boom tip 312 back into the neutral position of FIG. 9. While a helical spring 52 is shown, it is contemplated that other elastic elements can also be used. In an exemplary embodiment, pulley 62 serves a dampening function by controlling a rate at which cable 58 travels about pulley 62.

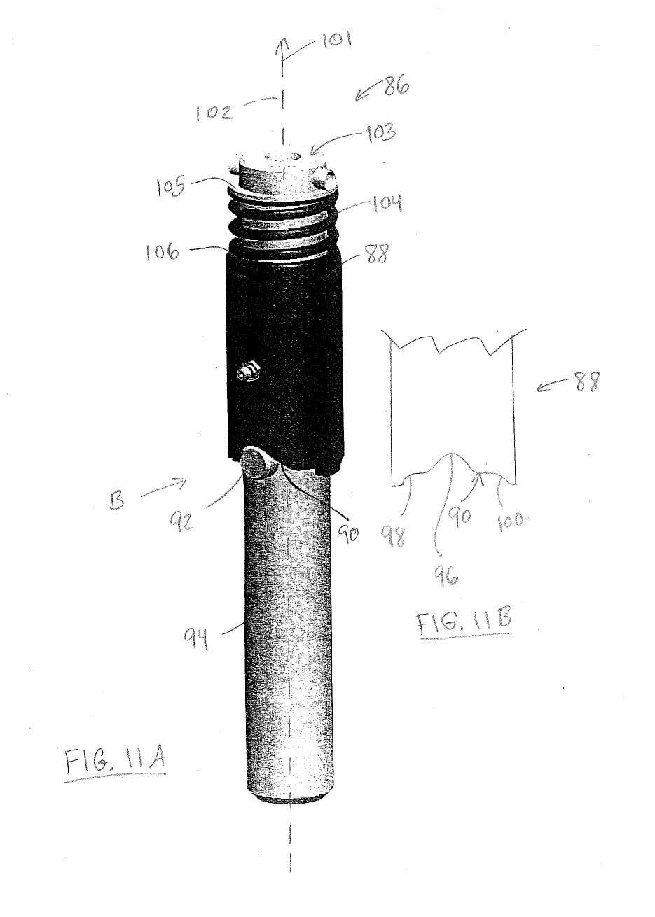

FIG. 10A is a side perspective view of inclined plane hinge 66, which embodies a third embodiment of a return mechanism. The disclosed return mechanisms may be used in combination or separately. For example, inclined plane hinge may be used for hinge 24, 26, 124, and/or 126 in any of the disclosed embodiments. First section 68 and second section 72 are aligned along longitudinal axis 78 of hinge 66. First section 68 is movable with respect to second section 72 along axis 78; moreover, first section 68 is rotatable with respect to second section 72 about axis 78. First section 68 is attached to one of boom tip 12, 112, 212, 312 or main boom portion 14, 114, 214, 314 by known fasteners via attachment flange 70. Second section 72 is attached to the other of boom tip 12, 112, 212, 312 or main boom portion 14, 114, 214, 314 by known fasteners via attachment flange 74. Central hinge pin 76 keeps the sections 68, 72 of hinge 66 aligned along hinge axis 78. The interface 79 between the sections 68, 72 consists of first inclined plane 80 on first section 68, which is parallel to second inclined plane 82 on second section 72 in the configuration shown in FIG. 10A. First and second inclined planes 80, 82 are tilted with respect to longitudinal axis 78. In an exemplary embodiment, top portion 81 of hinge 66, which has flange 85, is fixed with respect to second section 72.

When boom tip 12, 112, 212, 312 moves relative to main boom portion 14, 114, 214, 314, the connected sections 68, 72 twist relative to each other about hinge axis 78. FIG. 10B is a side perspective view of the hinge 66, with first section 68 rotated approximately 90 degrees about hinge axis 78 relative to second section 72. Attachment flange 70 is not shown in FIG. 10B for clarity. While rotation in one direction is shown, it is to be understood that relative twisting of sections 68, 72 in an opposite direction also occurs in use. Sections 68, 72 will twist relative to each other in one direction in a forward break configuration of boom 10, 110 (shown in FIGS. 2A, 3A and 5A) and will twist relative to each other in the opposite direction in a rearward break configuration of boom 10, 110 (shown in FIGS. 2B, 3B and 5B). The particular direction of rotation of sections 68, 72 for each of the forward and rearward configurations of boom 10, 110 depends upon which of flanges 70, 74 is connected to boom tip 12, 112, 212, 312; the other flange 70, 74 is connected to main boom portion 14, 114, 214, 314.

The relative motion of sections 68, 72 is constrained linearly along hinge axis 78 by hinge pin 76. Such relative motion causes tip 84 of first inclined plane 80 to ride upward along inclined plane 82. Thus, while first section 68 twists relative to second section 72 about hinge axis 78, first section 68 also moves in direction 83 relative to second section 72. Spring 86 is constrained between flange 85 of top portion 81 and surface 77 of first section 68. Accordingly, upward movement of first section 68 compresses spring 86. While a helical coil spring is shown, it is contemplated that another biasing mechanism can be used. The inherently unstable configuration of inclined plane hinge 66 shown in FIG. 10B and the spring recovery force from compressed spring 86 cause inclined plane hinge 66 to return to its stable, neutral configuration, as shown in FIG. 10A, after the obstacle that caused the forward or rearward pivoting of boom tip 12, 112, 212, 312 relative to main boom portion 14, 114, 214, 314 is passed. While a single interface 79 between first section 68 and second section 72 is illustrated, it is to be understood that hinge 66 may include multiple parallel inclined plane interfaces, with multiple corresponding sets of counter-rotating first and second sections.

FIG. 11A is a side perspective view of a cam hinge 86 that embodies a fourth embodiment of a return mechanism. First section 88 and second section 94 are aligned along longitudinal axis 102 of hinge 86. First section 88 is movable with respect to second section 94 along axis 102; moreover, first section 88 is rotatable with respect to second section 94 about axis 102. In an exemplary embodiment, first section 88 includes a cam surface 90 on which stud 92 of second section 94 travels. The disclosed return mechanisms may be used in combination or separately. For example, the cam hinge may be used for hinge 24, 26, 124, and/or 126 in any of the disclosed embodiments. First section 68 is attached to one of boom tip 12, 112, 212, 312 or main boom portion 14, 114, 214, 314 by known fasteners via attachment an attachment flange (not shown, but similar to attachment flange 70 of inclined plane hinge 66). Second section 72 is attached to the other of boom tip 12, 112, 212, 312 or main boom portion 14, 114, 214, 314 by known fasteners via an attachment flange (not shown, but similar to attachment flange 74 of inclined plane hinge 66). FIG. 11B is a partial side elevation view of first section 88, from vantage B. Cam surface 90 includes central peak 96 and two opposite end points 98, 100.

As shown in FIG. 11A, when boom tip 10, 110 is in the neutral position (shown in FIGS. 1, 4, 6, 8 and 9), stud 92 is positioned at central peak 96 of cam surface 90 (and is urged into that position by spring 104). When boom tip 12, 112, 212, 312 moves relative to main boom portion 14, 114, 214, 314, the connected sections 88, 94 twist relative to each other about hinge axis 102, and spring 104 is further compressed. Sections 88, 94 will twist relative to each other in one direction in a forward break configuration of boom 10, 110 (shown in FIGS. 2A, 3A and 5A) and will twist relative to each other in the opposite direction in a rearward break configuration of boom 10, 110 (shown in FIGS. 2B, 3B and 5B). The particular direction of rotation for sections 88, 94 during each of the forward and rearward configurations of boom 10, 110 depends upon which of attachment flanges is connected to boom tip 12, 112, 212, 312; the other attachment flange is connected to main boom portion 14, 114, 214, 314.

In an exemplary embodiment, top portion 103 of hinge 86, which has flange 105, is fixed with respect to second section 94. While first section 88 twists relative to second section 94 about hinge axis 78, first section 68 also moves in direction 101 relative to second section 94 because of the travel of stud 92 along contoured cam surface 90. Such twisting causes stud 92 of second section 94 to travel along cam surface 90 toward one of end points 98, 100. Spring 104 is constrained between flange 105 of top portion 103 and surface 106 of first section 88. Accordingly, upward movement of first section 88 compresses spring 104. While a helical coil spring is shown, it is contemplated that another biasing mechanism can be used. The spring recovery force from compressed spring 104 causes cam hinge 86 to return to its stable, neutral configuration, as shown in FIG. 11A, after the obstacle that caused the forward or rearward pivoting of boom tip 12, 112, 212, 312 relative to main boom portion 14, 114, 214, 314 is passed.

Although the subject of this disclosure has been described with reference to several embodiments, workers skilled in the art will recognize that changes may be made in form and detail without departing from the spirit and scope of the disclosure. For example, while the illustrated embodiments show structures in which certain elements are attached to the main boom portion and complimentary elements are attached to the boom tip, it is contemplated that these features may be reversed. In addition, any feature disclosed with respect to one embodiment may be incorporated in another embodiment, and vice-versa.

What is claimed is:

1. A break-away joint apparatus for a boom arm having a front side and a back side, the boom arm comprising a main boom portion and a boom tip, the apparatus allowing the boom tip to assume a neutral position and to pivot to a forward position and to a rearward position with respect to the main boom portion, the apparatus comprising:
a first hinge connected to the main boom portion proximate one of the front or back side of the boom arm;
a second hinge connected to the boom tip proximate an opposite side of the boom arm; and
a pivot plate having first and second opposite sides, the first side connected to the first hinge and the second side connected to the second hinge.

2. The apparatus of claim 1 wherein the first and second hinges are parallel to each other.

3. The apparatus of claim 1 wherein the first and second hinges converge toward each other at a top of the pivot plate.

4. The apparatus of claim 1 wherein each of the first and second hinges is tilted at an acute angle to a direction that is perpendicular to a bottom surface of the boom arm.

5. The apparatus of claim 4 wherein the acute angle of the first hinge is equal to the acute angle of the second hinge.

6. The apparatus of claim 1 wherein the boom tip pivots upwardly when it pivots forward or rearward.

7. The apparatus of claim 1 wherein:
the first hinge is connected to the main boom portion via a first plate; and
the second hinge is connected to the boom tip via a second plate.

8. The apparatus of claim 1 wherein the pivot plate has a central aperture therethrough.

9. The apparatus of claim 1 comprising a return mechanism to return the boom tip to the neutral position from either of the forward position or the rearward position with respect to the main boom portion.

10. The apparatus of claim 9 wherein the return mechanism comprises a spring.

11. The apparatus of claim 9 wherein the return mechanism comprises a spring having first and second ends, wherein the first end is connected to the main boom portion and the second end is connected to the boom tip.

12. The apparatus of claim 9 wherein the return mechanism comprises a pulley.

13. The apparatus of claim 9 wherein the return mechanism comprises a cable.

14. The apparatus of claim 9 wherein the return mechanism comprises:
a spring and cable connected to one of the main boom portion and the boom tip; and
a pulley connected to the other of the main boom portion and the boom tip, wherein the cable travels around the pulley.

15. The apparatus of claim 1 wherein at least one of the first and second hinges comprises a first section that is aligned along a longitudinal axis with a second section, wherein the first section is movable with respect to a second section along the longitudinal axis and wherein the first section is rotatable with respect to a second section about the longitudinal axis.

16. The apparatus of claim 15 further comprising a spring constrained between the first section and a portion that is fixed to the second section.

17. The apparatus of claim 15 wherein an interface between the first and second sections comprises:
a first plane surface on the first section that is inclined with respect to the longitudinal axis; and
a second plane surface on the second section that is inclined with respect to the longitudinal axis, wherein the first and second plane surfaces are movable with respect to each other.

18. The apparatus of claim 17 wherein the first and second plane surfaces are selectively movable to be parallel to each other.

19. The apparatus of claim 15 wherein the second section comprises a stud that travels along a contoured surface of the first section.

20. The apparatus of claim 19 wherein the contoured surface comprises a central peak and two opposite end points.
